(19) United States
(12) Patent Application Publication
(10) Pub. No.: US 2025/0172709 A1
(43) Pub. Date: May 29, 2025

(54) METHOD FOR LOCATING HOT SPOTS

(71) Applicants: Commissariat à l’Énergie Atomique et aux Énergies Alternatives, Paris (FR); Centre National de la Recherche Scientifique, Paris Cedex 16 (FR); UNIVERSITÉ DE BOURGOGNE, Dijon (FR)

(72) Inventors: Adrien FRIGERIO, Is sur Tille (FR); Kélian THIS, Is sur Tille (FR); Sébastien COLAS, Is sur Tille (FR); Hervé CARDOT, Dijon (FR); Xavier DUPUIS, Dijon (FR)

(73) Assignees: Commissariat à l’Énergie Atomique et aux Énergies Alternatives, Paris (FR); Centre National de la Recherche Scientifique, Paris Cedex 16 (FR); UNIVERSITÉ DE BOURGOGNE, Dijon (FR)

(21) Appl. No.: 18/961,755

(22) Filed: Nov. 27, 2024

(30) Foreign Application Priority Data
Nov. 28, 2023 (FR) 2313144

(51) Int. Cl. G01T 1/36; G01T 1/29

(52) U.S. Cl. CPC G01T 1/36; G01T 1/2914

(57) ABSTRACT

The invention relates to a method for locating hot spots, with a measuring device, comprising:
a detector (10),
a measuring circuit (12) configured to determine a number of pulses detected by the detector;
the method comprising:
acquiring measurements (Sₘ) facing the object, each measurement corresponding to a measurement position (pₘ) and an orientation of the detector (φₘ);
forming an observation vector (y) based on count rates extracted from the measurements;
selecting a number of hot spots (N) in the object;
initialising a parameter vector (θₖ), containing a position (πₙ) of at least one hot spot; refreshing a direct matrix model, relating an estimate of the observation vector (ŷ) to an intensity vector (ϕₖ);
inverting the direct model and updating the parameter vector (θₖ) and the intensity vector (ϕₖ);
reiterating the last two steps.

### TECHNICAL FIELD

The technical field of the invention is spectrometry applied to the detection of ionising radiation and to location of hot spots emitting ionising radiation. It is essentially a question of X-ray or γ-ray spectrometry.

### PRIOR ART

In the equipment of nuclear installations, radiological activity is not evenly distributed. It is generally concentrated in zones that are usually called “hot spots”. Generally, the intensity and location of hot spots are unknown, as they depend on the operating history of the nuclear installation. However, when a radiological inventory of a nuclear installation is carried out, it is useful to know, as far as possible, the location of hot spots and their respective activities.

Gamma cameras inspired by imagers used in the medical field have been undergoing development since the 1990s. Gamma cameras are devices that make it possible to form an image allowing a map of nuclear installations to be established. The objective is to locate and identify, remotely, the main radiation sources present in an installation. The development and the use of gamma cameras have been extensively described in the literature. Spectrometric gamma cameras have been undergoing development since the early 2000s. These cameras are based on a pixelated imager, each pixel making it possible to obtain a spectrum of the radiation that it detects. A considerable improvement in the location of radiation sources results. Specifically, the spectrometric function makes it possible to select energy bands of interest, corresponding to unscattered photons, i.e. photons that have not been deviated since their emission by the radiation source.

These devices are high-performance but quite expensive. Their sensitivity may be insufficient when the activity is due to isotopes that are weak γ emitters, isotopes of Pu for example. Thus, gamma cameras may have an insufficient sensitivity for inspections aiming to accurately inventory nuclear materials, or to assess criticality risk. A typical example is quantification of the accumulation of nuclear material in a glove box, for example in installations for manufacturing nuclear fuel.

At the present time, gamma cameras allow an estimation of the dose generated by each detected hot spot. However, if it is desired to estimate the activity of the detected hot spots, it is necessary to resort to modelling means. This requires certain modelling assumptions, and a certain level of expertise. It will be understood that estimation of the activity of hot spots is dependent to a large extent on user experience.

The invention described below makes it possible to locate and quantify the activity of hot spots, using a simple measuring device. It is particularly suitable for installations in which small amounts of radiation are generated by gamma emitters having a low emission intensity. It is also suitable for environments in which access conditions are constrained, and in particular for cluttered environments. Beyond the nuclear field, the invention may also be used to search for hot spots in other types of application, medical applications for example.

### SUMMARY OF THE INVENTION

A first subject of the invention is a method for locating hot spots in an object, each hot spot emitting gamma photons at least at one emission energy, the method employing a measuring device, the measuring device comprising:

a detector configured to detect the gamma photons, and to form a pulse on each detection;

a measuring circuit, configured to determine a number of detected pulses;

the process comprising the following steps:
a) acquiring measurements facing the object, each measurement corresponding to a measurement position and an orientation of the detector, the measurements being acquired by placing the detector in various measurement positions and/or with various orientations;
b) processing the measurements, by means of the measuring circuit, so as to extract count rates;
c) forming an observation vector based on the count rates extracted in step b);
d) selecting a number of hot spots in the object;
e) initialising a parameter vector, containing a position of at least one hot spot situated in the object;
f) based on the initialised parameter vector resulting from e), or on the parameter vector resulting from a previous iteration, refreshing a direct matrix model, relating an estimate of the observation vector to an intensity vector, the intensity vector containing an estimate of the intensity of each hot spot;
g) inverting the direct model, by means of an optimisation algorithm, so as to update the parameter vector and the intensity vector;
h) reiterating steps f) and g) until an iteration stop criterion is met, so as to obtain, following the last iteration, an estimate of the parameter vector and the intensity vector corresponding to the number of selected hot spots.

According to one embodiment, referred to as the spectrometric embodiment:
the measuring circuit is a spectrometric measuring circuit, configured to form a spectrum, the spectrum corresponding to a number of photons detected in various channels, each channel corresponding to an energy of the detected photon;
the measuring circuit comprises a spectrometry unit configured to identify at least one emission peak in the spectrum formed by the spectrometric measuring circuit, each emission peak extending about an emission energy;
   the method may be such that:
in step a), each measurement is a spectrum;
step b) comprises processing spectra, by means of the spectrometry unit, so as to extract count rates from each emission peak.

According to one possibility, in step g), the inversion comprises minimising a cost function, the cost function quantifying a discrepancy between the estimate of the observation vector obtained in step f);
the observation vector formed in step c).

Step g) may be performed by a maximum likelihood algorithm.

According to one possibility:
steps d) to h) are reiterated taking into account, in each iteration of steps d) to h), different numbers of hot spots;
the method comprises determining a validity indicator associated with each iteration of steps d) to h), the validity indicator being associated with the number of hot spots selected in each iteration;
the method comprises estimating the most likely number of hot spots depending on the various validity indicators respectively associated with various numbers of hot spots.

The validity indicator may be an Akaike information criterion.

According to one possibility, the direct model comprises a response matrix formed of a Hadamard product between at least:
a distance matrix, expressing the respective distances between each measurement position and the position of each hot spot, each term of which matrix contains the square of the distance between a measurement position and a position of a hot spot, the position of each hot spot forming a parameter of the direct model;
an efficiency matrix, expressing the efficiency of the detector, each term of which corresponds to a detection efficiency of the detector for a position and orientation of the detector and for a position of a hot spot at least at one emission energy.

The direct model may comprise a response matrix formed of a Hadamard product between at least:
a distance matrix, expressing the respective distances between each measurement position and the position of each hot spot, each term of which matrix contains the square of the distance between a measurement position and a position of a hot spot, the position of each hot spot forming a parameter of the direct model;
an efficiency matrix, expressing the efficiency of the detector, each term of which corresponds to a detection efficiency of the detector for a position and orientation of the detector and for a position of a hot spot.

The response matrix may be formed from a Hadamard product between the distance matrix, the efficiency matrix and an attenuation matrix, the attenuation matrix expressing an attenuation of the photons emitted by each hot spot in the object, each term of the attenuation matrix containing an attenuation factor expressing, at an emission energy, an attenuation between a position of a hot spot and a position of the detector, each attenuation factor forming one parameter of the direct model.

Step (e) may comprise:
e1) based on the observation vector resulting from c), computing an observation vector in the absence of attenuation in the object;
e2) estimating the observation vector in the absence of attenuation in the object using a direct model comprising the distance matrix and the efficiency matrix;
e3) inverting the direct model, so as to estimate an initialised parameter vector and an initial intensity vector, taking into account the number of hot spots taken into account in step d).

According to one possibility:
for a given number of hot spots selected in the object, steps e) to h) are reiterated;
the method comprises comparing cost functions resulting from each step g) of each iteration of steps e) to h), the parameter vector and the intensity vector, for the number of hot spots selected, being those corresponding to the minimum cost function.

According to one possibility, step g) comprises:
g1) applying a gradient descent algorithm to estimate the parameter vector, on the basis of the initial intensity vector or of the intensity vector resulting from a previous iteration,
g2) applying an inversion algorithm, to estimate the intensity vector, using the parameter vector resulting from g1).

According to one possibility, for a given number of selected hot spots, the method comprises:
a first series of iterations of steps e) to h), using a direct model in which the response matrix consists of a Hadamard product of the distance matrix and of the sensitivity matrix of the detector;
a second series of iterations of steps e) to h), using a direct model in which the response matrix is formed by a Hadamard product of the distance matrix, of the sensitivity matrix of the detector and of the attenuation matrix;
the position and activity of the hot spots resulting from the first series of iterations is used to initialise the inversion of the direct model in the first iteration of the second series of iterations.

According to one embodiment, step b) comprises selecting at least one emission energy of a predetermined isotope. The count rates are thus extracted at each selected emission energy. Steps b) to h) may be carried out by successively selecting, in each step b), at least one emission energy of various isotopes.

Following step h), the method may comprise estimating a dose rate at least at one measurement point, based on the intensity vector and on the parameter vector resulting from said step h).

According to one possibility, the method comprises:
updating the distance matrix and the efficiency matrix, depending on the parameter vector resulting from step h);
taking into account mass absorption coefficients at least at one emission energy;
estimating the dose rate at each measurement point based on the distance matrix, on the efficiency matrix and on the absorption coefficients.

In the spectrometric embodiment, the dose rate may be estimated, at each measurement point, for various emission energies respectively corresponding to various peaks in the spectrum formed on each measurement.

A second subject of the invention is a device configured to estimate a position of hot spots in an object, the device comprising:
a detector, configured to detect gamma photons, and to form a pulse on each detection, the detector being movable around the object, so as to be able to be placed in a plurality of positions and/or with various orientations with respect to the object;
a measuring circuit, configured to determine a number of pulses detected by the detector;
a processing unit, programmed to carry out steps c) to h) of a method according to the first subject of the invention, based on the number of pulses detected by the measuring circuit.

According to one possibility:
the measuring circuit is a spectrometric measuring circuit, configured to form a spectrum, the spectrum corresponding to a number of photons detected in various channels, each channel corresponding to an energy of the detected photon;
the measuring circuit comprises a spectrometry unit, configured to identify emission peaks in the spectrum formed by the spectrometric measuring circuit.

A third subject of the invention is a storage medium, connectable to a computer, comprising instructions for carrying out steps c) and e) to h), and optionally d), of a method according to the first subject of the invention based on count rates resulting from measurements carried out using a gamma-photon detector around an object.

The storage medium may be integrated into a computer or connected to a computer by a wired or wireless link.

The invention will be better understood on reading the description of the examples of embodiment presented, in the remainder of the description, with reference to the figures listed below.

### FIGURES

FIG. 1A shows an example of a device allowing the invention to be implemented, according to a first embodiment.

FIG. 1B shows various positions or orientations of the device according to the first embodiment around a studied object.

FIG. 2A shows one example of a spectrum.

FIG. 2B shows the spectrum shown in FIG. 2A after energy calibration.

FIG. 2C is a detail of FIG. 2A.

FIG. 2D is a detail of FIG. 2B.

FIG. 3A shows the main steps of a method for implementing the invention.

FIG. 3B shows steps in which first a parameter vector then an intensity vector is estimated, in each iteration.

FIG. 3C illustrates steps allowing each iteration to be initialised, when a plurality of numbers of hot spots are successively taken into account.

FIG. 3D illustrates steps allowing a dose rate to be estimated based on identified hot spots.

FIG. 4 schematically shows an efficiency curve of a detector.

FIG. 5 illustrates the performance obtained estimating a term of an observation vector, corresponding to the energy 129.3 keV, without taking into account screens in the object.

FIG. 6 illustrates a second embodiment of the invention.

FIGS. 7A and 7B illustrate an example of application to a glove box. FIG. 7A shows count rates of the observation vector, in one energy band, for various detector positions.

FIG. 7B shows an estimate of the distribution and mass of material in various hot spots in the glove box.

### DESCRIPTION OF PARTICULAR EMBODIMENTS

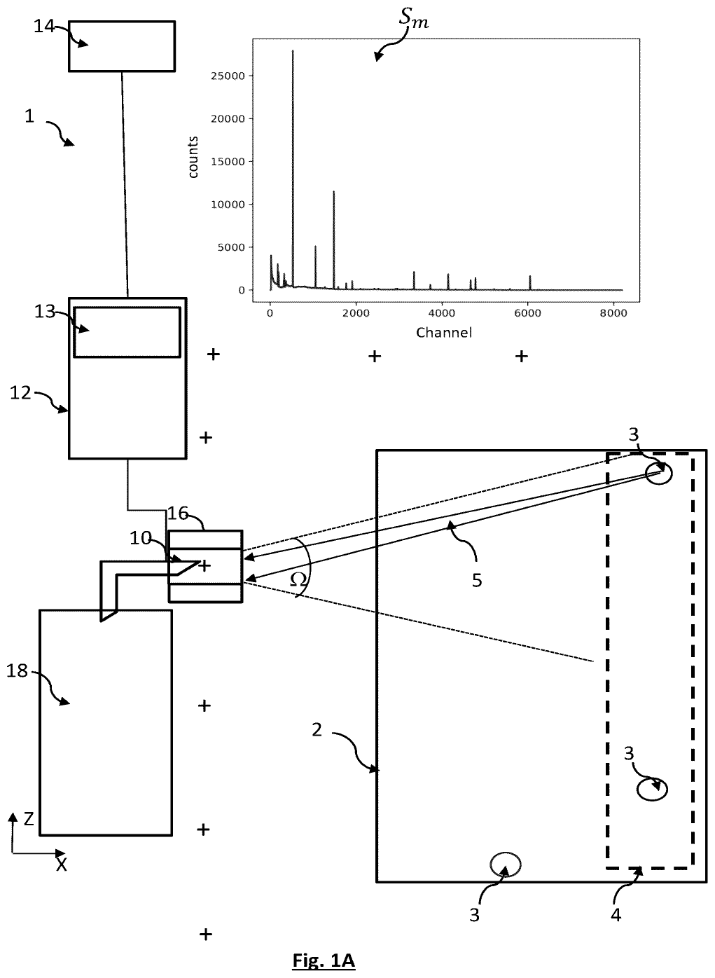

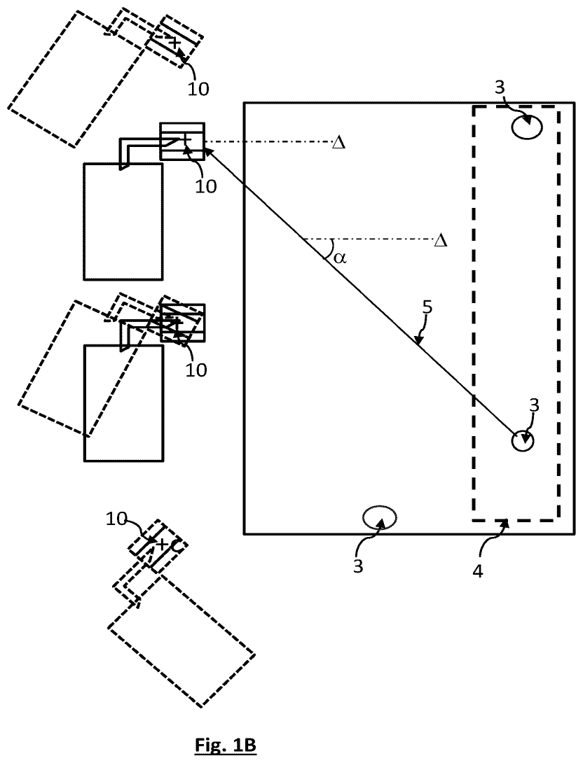

FIG. 1A shows a device 1 allowing the invention to be implemented, according to a first embodiment, called the spectrometric embodiment. The device is a measuring system, comprising a detector 10, able to interact with ionising radiation 5 emitted by an object 2. The object 2 is here a glove box, which may contain various hot spots 3 distributed in the glove box. The activity of each hot spot, and their distribution, is unknown. The invention is applicable to any type of object with which a nuclear installation is equipped, such as a civil-engineering structure, waste packages or various components. The invention is also applicable outside the nuclear field, in the medical field for example, for example to locate and quantify the activity of a radioisotope administered to the body of an individual.

In the example shown in FIG. 1A, the glove box comprises an area containing various pieces of equipment. The hot spots 3 are positioned in the area 4 and on the floor of the glove box. The position of each hot spot in a coordinate system XYZ associated with the studied object is designated πₙ. The index n is an integer, 1≤n≤ N, that identifies each hot spot. N corresponds to the number of hot spots. Generally, N is unknown. One objective of the invention is to determine the position πₙ and activity Øₙ of each hot spot.

It is assumed that the radionuclides liable to be present in a measured object are known beforehand. Otherwise, they may be determined by the spectrometry unit. A list of radionuclides 2ⱼ potentially present in the analysed object may notably be drawn up. The index j designates each radionuclide. The list of radionuclides, and their relative proportions, is assumed to be known, and forms a standard spectrum.

Otherwise, and this is the option that is described in the following example, the method is implemented radioisotope by radioisotope.

In the example shown, the detector comprises a semiconductor (germanium (Ge)); however another scintillator or semiconductor commonly used to detect ionising photons (for example Si, CdTe, CdZnTe, LaBr₃ or NaI) or even a gas detector, such as an ionisation chamber, could also be used.

Whichever detector is used, it allows an amount of charge Q to be collected under the effect of energy E released by the ionising radiation during an interaction in the detector 10. By ionising radiation, what is meant is X-ray or gamma-ray radiation formed from photons the energy of which is, for example, between 1 keV and 2 MeV.

The detector 10 is connected to a measuring circuit 12 configured to generate a pulse the amplitude of which depends on, and is preferably proportional to, the amount of charge collected during an interaction. The amount of charge corresponds to the energy deposited by the radiation during the interaction.

The measuring circuit 12 comprises a spectrometry unit 13, which makes it possible to gather all the pulses formed during an acquisition period. Each pulse corresponds to one interaction of the incident radiation in the detection material. The spectrometry unit 13 then classifies the pulses according to their amplitude Amp, to provide a histogram containing the number of pulses detected as a function of their amplitude. Such a histogram is an amplitude spectrum. It is usually obtained using a multichannel analyser. Each amplitude is discretised into channels, each channel being assigned one amplitude band. The value of each channel of the spectrum corresponds to a number of pulses the amplitude of which is situated in the amplitude band assigned to the channel. Each amplitude band corresponds to an energy band, the correspondence being bijective. Thus, each channel is assigned one energy band or one amplitude band.

The relationship between amplitude and energy may be determined by irradiating the detector with a calibration source, emitting radiation of known energy. It is in particular a question of radiation having at least one discontinuity, or energy peak, at a known energy value. This operation is usually designated by the term energy calibration. For example, in the context of gamma spectrometry, the detector is exposed to a ¹⁵²Eu calibration source, producing photons at known emission energies. It is also possible to employ a ¹³⁷Cs source, mainly producing photons with an energy of 661.6 keV. It is also possible to use a ⁶⁰Co source producing photons the energy of which is mainly 1173 keV and 1332 keV. The energy calibration may be performed as described in WO2023126509.

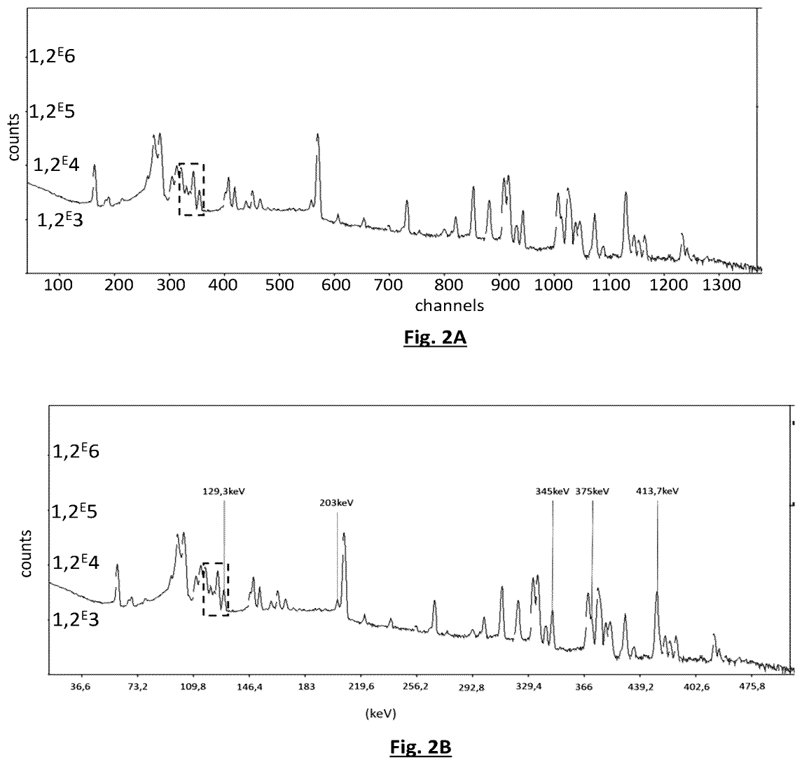

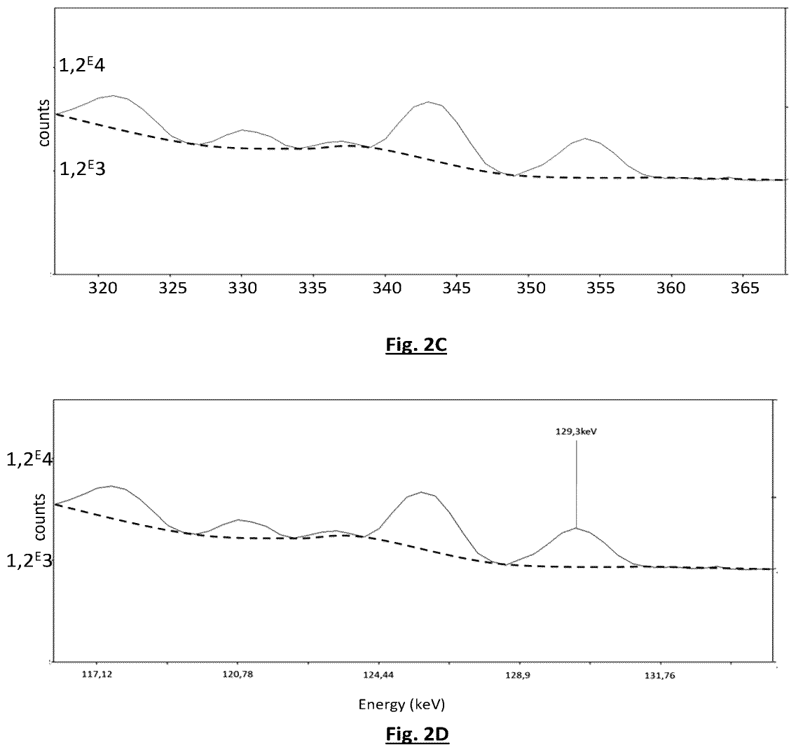

The spectrometry unit is configured to form an energy spectrum from the pulses formed in the processing circuit 12. The spectrometry unit is also configured to perform spectrum-processing operations, for example peak detection and determination of a spectral value at each peak. These operations are described in greater detail with reference to FIGS. 2A to 2D.

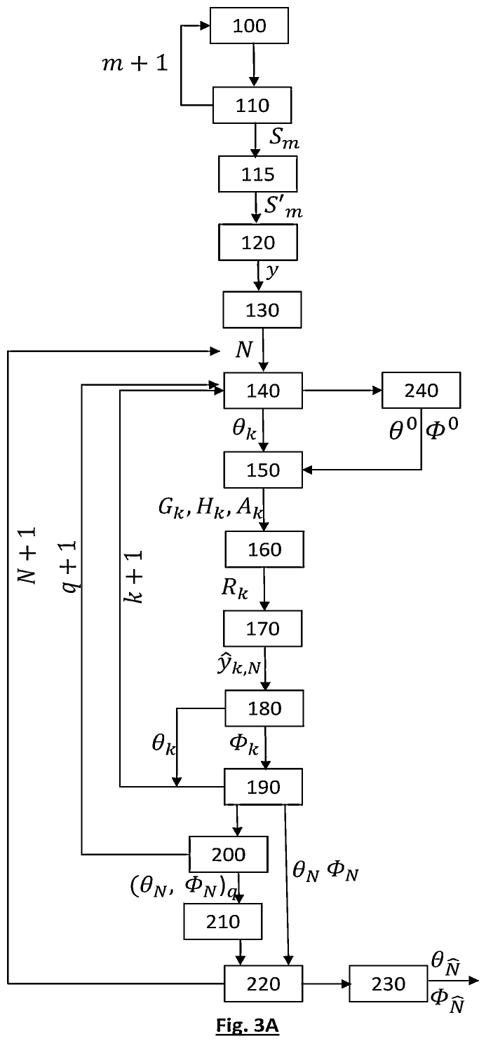

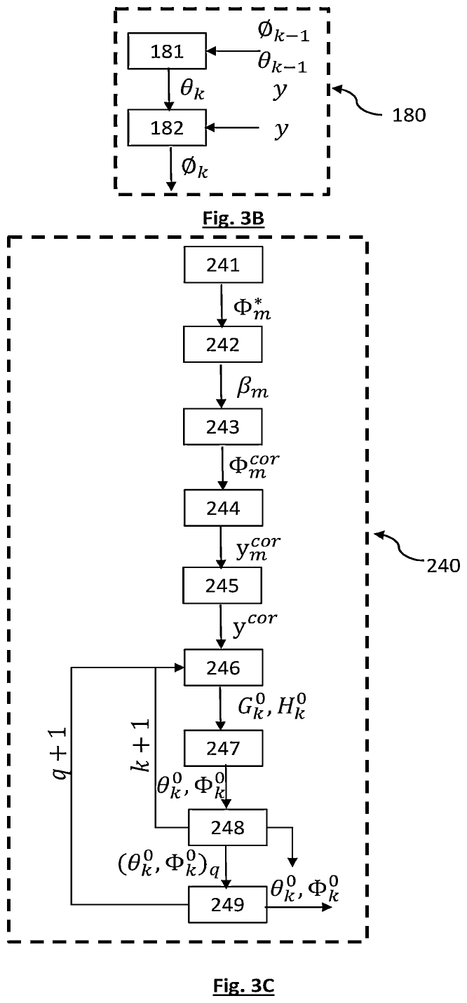

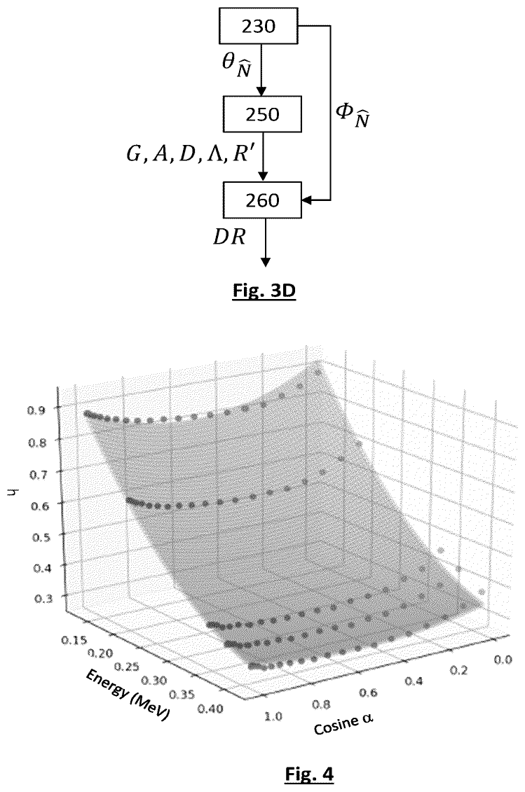

The device comprises a processing unit 14 programmed to implement steps of algorithms that are described below, with reference to FIGS. 3A to 3D, so as to locate each hot spot and to estimate the respective activities thereof.

In the example shown, the detector 10 is connected to a cryostat 18 containing liquid nitrogen so as to maintain the Ge detector at an operating temperature. The detector 10 is surrounded by shielding 16 so as to limit the influence of radiation emitted outside of an observation field Ω of the detector 10. In FIG. 1A, the limits of the observation field Ω have been represented by two dashed lines.

An important aspect of the invention is that the detector 10 is moved to various measurement points around the studied object 2. In FIG. 1A, each measuring point has been represented by a cross. Each measurement point corresponds to a position occupied by a reference point of the detector 10, its centre for example.

FIG. 1B shows the detector 10 placed at a plurality of measurement points around the studied object 2. At each measurement point, the detector is oriented with one or more orientations. Below, each measurement is identified by an integer m. Each measurement is taken in one position pₘ and with one orientation aₘ. Each position pₘ and each orientation aₘ comprises three spatial and angular coordinates in the coordinate system XYZ associated with the studied object 2, respectively.

FIG. 2A shows one example of a spectrum. The x-axis corresponds to amplitude, discretized into amplitude channels, and the y-axis represents a number of pulses counted at each amplitude during acquisition of the spectrum. FIG. 2B shows the same spectrum after energy calibration. Each amplitude channel is assigned one energy value.

Certain commercial software packages allow automatic peak detection and estimation of the intensity of the detected peaks. By estimation of the intensity, what is meant is estimation of the area of each peak. FIGS. 2C and 2D schematically show extraction of an area of a peak, in a region of interest indicated by a box in FIGS. 2A and 2B. In FIGS. 2C and 2D, the area of a peak is extracted “above” the background noise level, the latter being represented by a dashed line. The extracted area corresponds to an intensity of the peak at the emission energy of the peak, the latter corresponding to the x-coordinate of said peak. Document WO2023126508 describes a method allowing an area of a peak to be automatically extracted, as an alternative to currently available commercial software packages.

Compared to gamma cameras, one advantage of using a non-pixelated spectrometry device is that the detection volume may be large. For example, about 1 inch in diameter and 1 inch in height, or even more for a LaBr3 detector. Using germanium detectors allows larger volumes to be covered. A good measurement sensitivity is achieved. Thus, low levels of radiation may be addressed, this being particularly necessary when it is a question of weak emitters, such as certain isotopes of Pu. Low levels of activity may also be addressed for isotopes that are strong gamma emitters, ¹³⁷Cs or ⁶⁰Co for example.

The high detection volume may be combined with use of long acquisition times, for example several tens of seconds, or even several minutes or tens of minutes. This makes it possible to obtain a very good detection sensitivity, especially since spectrometry allows selection of peaks at certain previously determined energies.

The main steps of one detecting method are described with reference to FIG. 3A.

Step 100: placing the detector in a measurement position pₘ and orientation aₘ around the object. Thus, each measurement m is associated with one measurement position pₘ and orientation aₘ.

Step 110: acquiring a spectrum Sₘ

Steps 100 and 110 are repeated so as to obtain M measured spectra. Each measured spectrum Sₘ is associated with one measurement position or orientation.

Step 115: extracting the area of the peaks.

In this step, the spectrum is analysed by the spectrometry unit, so as to extract an area of each peak. For each peak a count rate, which corresponds to a number of pulses detected in the peak divided by unit of time, is determined. This makes it possible to form, for each measurement m, a vector S′ₘ, of size L, each term S′ₘ(λ₁) of which is an area of a peak detected by the spectrometry unit at an emission energy λₗ.

Each energy corresponds to one radioisotope, emitting a photon at said energy with a branching ratio iₗ, where l is an index designating the energy. iₗ is a number of photons emitted for a radioisotope activity of 100 Bq.

Step 120: selecting one or more isotopes and forming the observation vector.

In this step, one or more isotopes the emission energies of which correspond to the energies detected by the detector are selected. A single isotope may be selected or all the isotopes may be selected and a fraction w; assigned to each thereof. Said fraction may be estimated, to the first order, by the spectrometry unit, or result from a known, for example obtained by sampling or knowledge of an operating history.

Based on the vector S′ₘ of the extracted areas, it is possible to compute, for each extracted isotope j in question, an observation vector yₘ for measurement m such that:

$${y}_{m} = {w}_{j} \frac{{s}_{m}^{′}}{{i}_{l} {t}_{m}} \times 100 \qquad ( 1 )$$

tₘ corresponding to an integration time of the spectrum Sₘ.

When the method is implemented for a single isotope, the vector yₘ is defined only for all or some of the isotope emission energies detected by spectrometry, and wⱼ=1. In this case, L corresponds to a number of emission energies taken into account for the isotope in question. Advantageously, the method is successively implemented for a single isotope, successively considering each isotope identified in view of the detected spectra.

The M observation vectors yₘ for each measurement are concatenated to form an observation vector y, of size ML.

The observation vector y is such that:

$$y = [ \begin{matrix}{y}_{1} ( {λ}_{1} ) \\ ⋮ \\ {y}_{1} ( {λ}_{L} ) \\ ⋮ \\ {y}_{M} ( {λ}_{1} ) \\ ⋮ \\ {y}_{M} ( {λ}_{L} )\end{matrix} ] \qquad ( 2 )$$

Each term yₘ(λₗ) is a count rate of a peak detected during a measurement m at the energy λₗ, normalised by the branching ratio iₗ of the isotope at the energy l. Thus, each term yₘ(λₗ) is uniform in pulses detected per second for 1 photon emitted per second.

L is an integer indexing the energy, with 1≤1≤L.

Step 130: selecting a number of hot spots N.

In this step, a number N of hot spots to be located in the object is arbitrarily defined. N is a strictly positive integer. Advantageously, N may be gradually increased, as described below.

The steps described below are iterative steps. k is an integer designating the rank of each iteration. 1≤k≤K

Step 140: Defining a parameter vector θₖ.

The parameter vector θₖ contains certain unknowns, in particular the position πₙ of each hot spot and, optionally, attenuation parameters π_{n,λ}. Each attenuation parameter quantifies the attenuation of the radiation, at energy λ, emitted by the hot spot n. The index n designates each hot spot, at the position πₙ, with 1≤n≤N.

In the first iteration, (k=1), the parameter vector θₖ is initialised arbitrarily, or based on a known. This is the purpose of step 240. The parameter vector θₖ may be initialised as described in connection with steps 241 and 249 described below, with reference to FIG. 3C.

Step 150: forming matrices allowing a direct model to be established.

In this step, a plurality of matrices is formed allowing the direct model to be formed.

A distance matrix Gₖ expresses the respective distances between the measurement position pₘ of each measurement m and the position of each hot spot π_{1,k}, each term of which matrix corresponds to the inverse of the square of the distance between a measurement position and a position of a hot spot, the position of each hot spot forming a parameter of the direct model.

In the first iteration (k=1), the position of each hot spot π_{n,k} corresponds to an initial position, resulting from an initialisation phase, which is described below. When (k>1), the position of each hot spot corresponds to the position updated in the previous iteration.

$${G}_{k} = [ \begin{matrix}\frac{1}{{‖ {p}_{1} - {π}_{1 , k} ‖}^{2}} & & \frac{1}{{‖ {p}_{1} - {π}_{N , k} ‖}^{2}} \\ ⋮ & … & ⋮ \\ \frac{1}{{‖ {p}_{M} - {π}_{1 , k} ‖}^{2}} & & \frac{1}{{‖ {p}_{M} - {π}_{N , k} ‖}^{2}} \\ ⋮ & ⋱ & ⋮ \\ \frac{1}{{‖ {p}_{1} - {π}_{1 , k} ‖}^{2}} & & \frac{1}{{‖ {p}_{1} - {π}_{N , k} ‖}^{2}} \\ ⋮ & … & ⋮ \\ \frac{1}{{‖ {p}_{M} - {π}_{1 , k} ‖}^{2}} & & \frac{1}{{‖ {p}_{M} - {π}_{N , k} ‖}^{2}}\end{matrix} ] \qquad ( 3 )$$

The matrix Gₖ is formed by a concatenation of L blocks

$$\begin{matrix}\frac{1}{{‖ {p}_{1} - {π}_{1 , k} ‖}^{2}} & & \frac{1}{{‖ {p}_{1} - {π}_{N , k} ‖}^{2}} \\ ⋮ & … & ⋮ \\ \frac{1}{{‖ {p}_{M} - {π}_{1 , k} ‖}^{2}} & & \frac{1}{{‖ {p}_{M} - {π}_{N , k} ‖}^{2}}\end{matrix}$$

In the matrix Gₖ, each term

$$\frac{1}{{‖ {p}_{m} - {π}_{n , k} ‖}^{2}}$$

is the inverse of the square of the distance between the position πₙ in iteration k, and the position pₘ of the detector during the measurement of rank m. This is equivalent to taking into account the attenuation of the photons 5 emitted by the hot spot positioned at π_{1,n′}, since the photons are detected by the detector under the effect of distance. The hot spot is considered to be point-like with respect to the detector.

An efficiency matrix Hₖ expresses the efficiency of the detector at the various emission energies resulting from step b), each term of which matrix corresponds to a detection efficiency of the detector for a given position and orientation of the detector and for a given position of a hot spot. The efficiency matrix Hₖ may for example be established on the assumption that the response function of the detector, at an emission energy λₗ, depends only on the angle of incidence α of the photons generated by each hot spot present in the observation field. As shown in FIG. 1B, the angle of incidence α is measured with respect to an axis A normal to the detector 10, and forming an axis of symmetry of the detector. This assumes that the response of the detector is axisymmetric, and that each hot spot may be considered to be sufficiently far away for the detected photons 5 to be considered to have the same angle of incidence.

It is assumed that

$${H}_{k} = [ \begin{matrix}h ( {λ}_{1} , {φ}_{{k}_{1.1}} ) & & h ( {λ}_{1} , {φ}_{{k}_{1 , N}} ) \\ ⋮ & … & ⋮ \\ h ( {λ}_{1} , {φ}_{{k}_{M , 1}} ) & & h ( {λ}_{1} , {φ}_{{k}_{M , N}} ) \\ ⋮ & ⋱ & ⋮ \\ h ( {λ}_{L} , {φ}_{{k}_{1.1}} ) & & h ( {λ}_{L} , {φ}_{{k}_{1 , N}} ) \\ ⋮ & … & ⋮ \\ h ( {λ}_{L} , {φ}_{{k}_{M , 1}} ) & & h ( {λ}_{L} , {φ}_{{k}_{M , N}} )\end{matrix} ] \qquad ( 4 )$$

In the matrix Hₖ, each term φₖ_{_{m,n}} corresponds to a cosine of the angle of incidence between the hot spot in question, in iteration k, in position πₙ, and the detector, during measurement m.

Each quantity h(λₗ,φk_{m,n}) corresponds to the detection efficiency, at the energy λₗ, of the radiation emitted by a hot spot located, in iteration k, in position πₙ, and the photons of which, detected by the detector situated at point pₘ, reach the latter at an angle of incidence the cosine of which is the φ_{m,n}. This efficiency corresponds to a ratio between the number of photons detected at the energy λₗ and the number of photons incident at this energy.

The case of a detector the efficiency of which is axisymmetric is a simplifying assumption. When such an assumption is invalid, efficiency may be determined taking into account two angular variables instead of just one.

FIG. 4 shows various values of an efficiency h of a detector as a function of energy (MeV) and of the cosine of the angle of incidence α. The detector taken into account is a cylindrical germanium detector with a surface area of 38 mm² and a thickness of 30 mm. The dots correspond to values modelled with the MCNP transport code. The sheet corresponds to a product of two polynomials of degree 2: a first polynomial the variable of which is energy and a second polynomial the variable of which is the cosine of the angle of incidence. FIG. 4 shows that, under the above assumptions, for a given detector, detection efficiency may be considered to depend, to a first approximation, only on φ_{m,n} and on the energy λₗ.

Optionally, but preferably, an attenuation matrix Aₖ is constructed. The attenuation matrix expresses an attenuation of the photons emitted by each hot spot in the object, each term of the attenuation matrix containing an attenuation factor expressing, at an emission energy, an attenuation between a position of a hot spot and a position of the detector, each attenuation factor forming one parameter of the direct model.

$${A}_{k} = [ \begin{matrix}{e}^{- \frac{{τ}_{{k}_{1.1}}}{{λ}_{1}}} & & {e}^{- \frac{{τ}_{{k}_{1 , N}}}{{λ}_{1}}} \\ ⋮ & … & ⋮ \\ {e}^{- \frac{{τ}_{{k}_{M , 1}}}{{λ}_{1}}} & & {e}^{- \frac{{τ}_{{k}_{M , 1}}}{{λ}_{1}}} \\ ⋮ & ⋱ & ⋮ \\ {e}^{- \frac{{τ}_{{k}_{1.1}}}{{λ}_{L}}} & & {e}^{- \frac{{τ}_{{k}_{1 , N}}}{{λ}_{L}}} \\ ⋮ & … & ⋮ \\ {e}^{- \frac{{τ}_{{k}_{M , 1}}}{{λ}_{L}}} & & {e}^{- \frac{{τ}_{{k}_{M , N}}}{{λ}_{L}}}\end{matrix} ] \qquad ( 5 )$$

Each term

$${e}^{- \frac{{τ}_{{k}_{m , n}}}{{λ}_{l}}}$$

corresponds to an attenuation of the photons detected by the detector, situated at the point pₘ, the photons being emitted by a hot spot located, in iteration k, at the position πₙ. The values τₖ_{_{m,n}} are attenuation terms of the parameter vector θₖ. Thus, the parameter vector θₖ contains each position π_{n,k} and each attenuation term τₖ_{_{m,n}}.

The method is able to function without necessarily implementing the attenuation matrix Aₖ, for example in applications involving sparse screens and/or high-energy gamma emitters. This is for example the case when the activity is spread over an area, in the absence of attenuating components in the studied object. In this case, the parameter vector θₖ contains only the position π_{n,k} of each hot spot in iteration k.

Each of the matrices Gₖ, Hₖ and Aₖ is parametrised by the parameter vector θₖ. Thus, each matrix is updated in each iteration. Each matrix formed in this step is of the same size: ML×N.

Step 160: forming the response matrix

From each matrix, or only from the matrices Gₖ, Hₖ, it is possible to form a response matrix Rₖ, such that:

Rₖ=Gₖ ⊙Hₖ⊙Aₖ (6) where ⊙ designates the Hadamard product (element-wise product).

Step 170: forming the direct model

Based on the response matrix Rₖ, it is possible to establish a direct model such that

$${\hat{y}}_{N , k} = {R}_{k} {ϕ}_{k} \qquad ( 7 )$$

ŷ_{N,k} corresponds to an estimate of the observation vector y, resulting from the direct model, in iteration k. The index N designates the fact that ŷN is estimated considering a number N of hot spots distributed in the object.

ϕₖ is a vector of size N that contains the activity of each hot spot, taking into account the emission lines and the branching ratios selected in step 120.

Expression (7) is equivalent to:

$${\hat{y}}_{N , k} ( m ; {λ}_{l} ) = {\sum }_{n = 1}^{N} \frac{{ϕ}_{n , k}}{{‖ {p}_{m} - {π}_{n , k} ‖}^{2}} h ( {λ}_{l} , {φ}_{{k}_{m , n}} ) {e}^{- \frac{{τ}_{{k}_{m , n}}}{{λ}_{l}}} \qquad ( {7}^{′} )$$

ŷ_{N,k}(m;λₗ) is an estimate of the term of the observation vector corresponding to the measurement m and to the energy λₗ.

Step 180: inverting the direct model.

Solution of the inverse problem given by (7) makes it possible to estimate the parameter vector θₖ and the vector ϕₖ together. To do this, a cost function expressing a discrepancy between the observation vector y and its estimate ŷ_{N,k} resulting from the direct model is established.

The cost function may be established using a maximum likelihood algorithm. It is then assumed that each measurement, corresponding to the observation vector y is an instance of a random variable Y. It is assumed that the measurements yₘ(λₗ), with 1≤m≤M and 1≤l≤L, are instances of independent random variables Y_{m,λ}_{ₗ} obeying a Poisson distribution of parameter ŷ_{N,k}(m;λₗ). It is assumed that the Poisson distribution may be approximated by a normal distribution if the parameter is large enough, i.e. in the case of peaks formed from at least 30 detected pulses. This corresponds to peaks that, after extraction in step 115, have an area corresponding to 30 pulses. S′ₘ(λₗ)≥30.

For each energy λₗ and each measurement point m, a likelihood function is defined such that

$${ℒ}_{N , k} ( {θ}_{k} , {ϕ}_{k} \vert y ( m , {λ}_{l} ) ) = \frac{1}{\sqrt{2 π {\hat{y}}_{N , k} ( m , {λ}_{l} ) )}} {e}^{- \frac{1}{2} {( \frac{y ( m , {λ}_{l} ) - {\hat{y}}_{N , k} ( m , {λ}_{l} )}{\sqrt{{\hat{y}}_{N , k} ( m , {λ}_{l} )}} )}^{2}} \qquad ( 8 )$$

Taking into account the L emission energies, and the M measurement points, the preceding expression may be extended—it is possible to define a likelihood function applied to the vector y, such that:

$${ℒ}_{N , k} ( {θ}_{k} , {ϕ}_{k} \vert y ) = {\prod }_{l = 1}^{L} {\prod }_{m = 1}^{M} \frac{1}{\sqrt{{\hat{y}}_{N , k} ( m , {λ}_{l} )}} {e}^{- \frac{1}{2} {( \frac{y ( m , {λ}_{l} ) - {\hat{y}}_{N , k} ( m , {λ}_{l} )}{\sqrt{{\hat{y}}_{N , k} ( m , {λ}_{l} )}} )}^{2}} \qquad ( 9 )$$

The log likelihood of [symbol] _{N,k}(θₖ,ϕₖ|y) is written

$$ln ( {ℒ}_{N , k} ( {θ}_{k} , {ϕ}_{k} \vert y ) ) = {\sum }_{l = 1}^{L} {\sum }_{m = 1}^{M} ( \frac{1}{\sqrt{2 π {\hat{y}}_{N , k} ( m , {λ}_{l} )}} ) - \frac{1}{2} {\sum }_{l = 1}^{L} {\sum }_{m = 1}^{M} {( \frac{y ( m , {λ}_{l} ) - {\hat{y}}_{N , k} ( m , {λ}_{l} )}{\sqrt{{\hat{y}}_{N , k} ( m , {λ}_{l} )}} )}^{2} \qquad ( 10 )$$

In order to optimise computation time, expression (10) is simplified by introducing y(m,λₗ) instead of ŷ_{N,k}(m,λₗ) into the variance estimators, so as to obtain:

$$ln ( {ℒ}_{N , k} ( {θ}_{k} , {ϕ}_{k} \vert y ) ) \approx {\sum }_{l = 1}^{L} {\sum }_{m = 1}^{M} ( \frac{1}{\sqrt{2 π y ( m , {λ}_{l} )}} ) - \frac{1}{2} {\sum }_{l = 1}^{L} {\sum }_{m = 1}^{M} {( \frac{y ( m , {λ}_{l} ) - {\hat{y}}_{N , k} ( m , {λ}_{l} )}{\sqrt{y ( m , {λ}_{l} )}} )}^{2} \qquad ( 11 )$$

Since the first term of (11) is independent of θₖ, the cost function to be minimised is

$${j}_{mv , N , k} ( {θ}_{k} , {ϕ}_{k} ) = - \frac{1}{2} {\sum }_{l = 1}^{L} {\sum }_{m = 1}^{M} {( \frac{y ( m , {λ}_{l} ) - {\hat{y}}_{N , k} ( m , {λ}_{l} )}{\sqrt{y ( m , {λ}_{l} )}} )}^{2} \qquad ( 12 )$$

This expression may be expressed in matrix form:

$${j}_{mv , N , k} ( {θ}_{k} , {ϕ}_{k} ) = - \frac{1}{2} {( {y}_{N , k} - {\hat{y}}_{N , k} )}^{T} {W}_{k} ( {y}_{N , k} - {\hat{y}}_{N , k} ) \qquad ( 13 )$$

$$with$$

$${W}_{k} = diag ( \frac{1}{y} ) \qquad ( 14 )$$

Wₖ is a matrix of size ML*ML and the diagonal of which contains the quantity

$$\frac{1}{y ( m , {λ}_{l} )} .$$

The parameters to be determined θₖ and ϕₖ are those maximising the likelihood function j_{mv,N,k}(θₖ,ϕₖ). Maximising the function j_{mv,N,k}(θₖ,ϕₖ) is equivalent to minimising the opposite function −j_{mv,N,k}(θₖ).

θₖ and ϕₖ may be estimated using:

$${θ}_{k} , {ϕ}_{k} = {arg min}_{{θ}_{k} ∈ \{ \prod , T \} ; {ϕ}_{k} ∈ {ℝ}_{+}^{N}} - ( {j}_{mv , N , k} ( {θ}_{k} , {ϕ}_{k} ) ) \qquad ( 15 )$$

Π corresponds to the volume of the examined object, and more precisely to the positions capable of being occupied by the hot spots. In the absence of a known, Π corresponds to the entirety of the examined volume.

T corresponds to a range of variation in the quantities τₖ_{_{m,n}}: it may be defined beforehand.

Step 190: reiterating steps 140 to 190

After θₖ and ϕₖ have been obtained, steps 140 to 180 are reiterated until an iteration stop criterion is met. The latter may be a predetermined number of iterations K or a difference between two successive values of the likelihood function j_{mv,N,k}(θₖ,ϕₖ) and j_{mv,N,k-1}(θₖ₋₁,ϕₖ₋₁) small enough to consider that convergence has been achieved. Steps 140 to 180 of the following iteration are implemented taking into account the parameter vectors θₖ and ϕₖ resulting from step 180.

After the iteration stop criterion has been met, the following are satisfied: θ_{N}=θ_{K} and ϕ_{N}=ϕ_{K}. K corresponds to the rank of the last iteration.

Experiments have shown that convergence is generally achieved in a few tens of iterations k, or for a number of iterations k of the order of one hundred.

Step 200: repeating steps 140 to 190.

Advantageously, steps 140 to 190 are reiterated Q times, considering the same number N of hot spots, Q being an integer typically between 10 and 100. A rank q is assigned to each iteration of these steps. In each step 190, a pair of vectors θ_{N}_{_{q}},ϕ_{N}_{_{q}} is obtained. With each pair of vectors θ_{N}_{_{q}},θ_{N}_{_{q}} is associated one value of the minimum cost function j_{mv,N,K}(O_{N}_{_{q}},ϕ_{N}_{_{q}}) resulting from the minimisation described above in connection with (15).

Step 210: selecting a pair θ_{N}_{_{q}},ϕ_{N}_{_{q}}

In this step, the pair ON, ON is selected from the pairs θ_{N}_{_{q}},ϕ_{N}_{_{q′}}, this pair being the one making it possible to obtain the minimum value among the Q values j_{mv,N,K}(θ_{N}_{_{q}},ϕ_{N}_{_{q}}) obtained in each repetition of steps 140 to 190.

Steps 200 and 210 are optional. They make it possible to obtain a number Q of minimisations. Thus, a parameter vector and an intensity vector allowing the discrepancy between y and its estimate ŷ_{N,K} to be minimised are obtained. This avoids obtaining values θ_{N} and ϕ_{N} resulting from an optimisation trap, namely minimisation resulting in a secondary minimum of the cost function.

Step 220: modifying the number N of hot spots

As indicated above, steps 140 to 190, and the optional steps 200 and 210, are preferably carried out successively with various values of N. For example, N is gradually increased from an initial value (for example N=1) to a final value. This makes it possible to obtain, for each value of N, a parameter vector θ_{N} and an intensity vector ϕ_{N}.

Step 230: selecting the most likely value of N

In this step, a validity indicator AIC_{N} associated with each number N taken into account beforehand is computed. The method comprises estimating the most likely number of hot spots depending on the various validity indicators. The most likely number of hot spots is the number for which the validity indicator is minimum.

The validity indicator may be the Akaike information criterion, such that:

$$AIC ( {\hat{y}}_{N , k} ) = - 2 ln ( {ℒ}_{N , k} ( {θ}_{N} , {ϕ}_{N} \vert {y}_{N , k} ) + 2 {κ}_{N} \qquad ( 16 )$$

$$with$$

$${κ}_{N} = 4 N + NM$$

Using (12),

$$AIC ( {\hat{y}}_{N , k} ) = cte + {j}_{mv , N , k} ( {θ}_{N} , {ϕ}_{N} ) + 2 {κ}_{N} \qquad ( 17 )$$

cte being a constant.

Since the number of measurements M is low, the corrected Akaike information criterion AICc is preferably used, such that:

$$AICc ( {\hat{y}}_{N , k} ) = AIC ( {\hat{y}}_{N , k} ) + 2 \frac{{κ}_{N} ( {κ}_{N} + 1 )}{ML - {κ}_{N} - 1} \qquad ( 18 )$$

On account of (17), expression (18) may be written

$$AICc ( {\hat{y}}_{N , k} ) = cte + {j}_{mv , N , k} ( {θ}_{N} , {ϕ}_{N} ) + 2 {κ}_{N} + 2 \frac{{κ}_{N} ( {κ}_{N} + 1 )}{ML - {κ}_{N} - 1} \qquad ( 19 )$$

The optimal number N of hot spots is the number for which the criterion AICc(ŷ_{N,k}) is minimum. Thus,

$$\hat{N} = {arg min}_{N} ( AICc ( {\hat{y}}_{N , k} ) ) \qquad ( 20 )$$

Following this step, the retained intensity vector is ϕ_{N̅}. Likewise, the retained parameter vector is θ_{N̅}.

According to one possibility, the Akaike information criterion may be replaced by another indicator, such as the Bayesian information criterion (BIC).

### Variants

The expression of the direct model, given by (7), involves the parameter vector θₖ and the intensity vector ϕₖ. The direct model is non-linear with respect to the parameter vector θₖ and linear with respect to the intensity vector ϕₖ. In step 180 described above, in each iteration k, θₖ and ϕₖ are estimated together.

It may be advantageous to estimate, in each iteration, θₖ and ϕₖ successively. For this purpose, step 180 is sub-divided into a sub-step 181 and a sub-step 182. See FIG. 3B. In sub-step 181, it is possible to implement a gradient-descent method, for example the Broyden-Fletcher-Goldfarb-Shanno method. This is equivalent to computing the gradient of the maximum likelihood with respect to the parameter vector θₖ.

$${\frac{\partial {j}_{mv , N , k} ( {θ}_{k} , {ϕ}_{k - 1} )}{\partial {θ}_{k}} = ( {G}_{k} ⊙ {H}_{k} ⊙ {A}_{k} ) {ϕ}_{k - 1} - {y}_{N , k} )}^{T} {W}_{k} \frac{\partial ( {G}_{k} ⊙ {H}_{k} ⊙ {A}_{k} ) {ϕ}_{k - 1}}{\partial {θ}_{k}} \qquad ( 21 )$$

Wₖ was defined in (14).

This makes it possible to update, in iteration k, the vector θₖ. To implement the preceding expression, ϕₖ₋₁ is used, which results from the previous iteration.

In sub-step 182, the direct model, given in (7), is solved by using a least-squares method to maximise the likelihood function (or minimise the opposite of the likelihood function), according to (13):

$${j}_{mv , N , k} ( {θ}_{k} , {ϕ}_{k} ) = - \frac{1}{2} {( {y}_{N , k} - {\hat{y}}_{N , k} )}^{T} {W}_{k} ( {y}_{N , k} - {\hat{y}}_{N , k} ) \qquad ( 22 )$$

$$and$$

$${ϕ}_{k , N} = {arg min}_{{ϕ}_{k , N}} ( {j}_{mv , N , k} ( {θ}_{k} , {ϕ}_{k} ) ) \qquad ( 23 )$$

The minimisation is carried out taking into account the vector θₖ resulting from sub-step 181.

The advantage of separate estimation of θₖ and of ϕₖ is that it decreases the size of the search space, decreasing the number of optimisation traps. It also makes it possible to separate out the quantity ϕₖ, the values of which vary over a much wider range than those of the parameter vector forming θₖ.

### Use of a Prior/Initialisation

Preferably, in each first iteration of steps 150 to 180, it is preferable to provide initial values for certain parameters, or even for certain activity levels. Otherwise, the values of the parameters are drawn according to a uniform distribution. This is of what step 240 consists.

The knowns may result from knowledge of an operating history, or from examinations implementing other modalities.

According to one possibility, in step 240, an initialisation is implemented before each first iteration of steps 150 to 180. The initialisation is implemented on each new value of N. The initialisation is described with reference to steps 241 to 249 of FIG. 3C.

In step 241, for each measurement m, a flux vector Φₘ* is formed, such that:

$${Φ}_{m}^{*} = \frac{{y}_{m}}{{h}_{de t}} \qquad ( 25 )$$

h̅_̅{̅d̅e̅t̅}̅ corresponds to an average of the efficiency vectors (size L), considering, at each energy, an average value of the extrema of efficiency as a function of angle of incidence. Each term Φₘ* of corresponds to an estimate, to a first approximation, of an equivalent activity per unit area in the object during the measurement m (photons emitted per unit area).

Step 242: It is a question of establishing the variation in Φₘ* as a function of energy, based on a simple relationship, so as to estimate the value of Φₘ* in the absence of screens in the object. Based on each term Φₘ*, two coefficients β_{1,m} and β_{2,m} are defined, such that

$${Φ}_{m}^{*} ( {λ}_{l} ) = {β}_{1 , m} + \frac{{β}_{2 , m}}{{λ}_{l}} \qquad ( 26 )$$

β_{1,m} is a positive real number and B_{2,m} is a negative real number.

β_{1,m} corresponds to the value of Φₘ*, when the energy tends to infinity. It may be likened, to a first approximation, to an equivalent surface activity, neglecting attenuation in the examined object.

β_{2,m} describes the variation in Φₘ* as a function of energy. This coefficient represents the ability of material forming a screen, in the studied object, to attenuate the radiation detected during the measurement m. Thus, β_{2,m} corresponds to an attenuation affecting measurement m.

Letting:

$${R}^{′} = [ \begin{matrix}1 & \frac{1}{{λ}_{1}} \\ ⋮ & ⋮ \\ 1 & \frac{1}{{λ}_{L}}\end{matrix} ] \qquad ( 27 )$$

and the vector βₘ=(β_{1,m};β_{2,m}) (28)
it is possible to estimate [symbol] according to the expression:

$$= {( {R}^{′ T} {R}^{′} )}^{- 1} W {R}^{′ T} ln ( {Φ}_{m}^{*} ) \qquad ( 29 )$$

with [symbol] =( [symbol] , [symbol] ) (30),
and W, a matrix of size ML*ML and the diagonal of which contains the quantity.

$$\frac{\overline{{h}_{d et}} ( {λ}_{l} )}{y ( m , {λ}_{l} )}$$

This step assumes that the selected isotope has a plurality of exploitable emission energies.

Step 243: estimating an equivalent activity of the object corresponding to each measurement.

Based on [symbol] a corrected observation vector is established, for measurement m, each term of which is:

$${y}_{m}^{cor} = {Φ}_{m}^{cor} \overline{{h}_{de t}} \qquad ( 31 )$$

$$with$$

$${Φ}_{m}^{cor} = \qquad ( 32 )$$

Φₘ^{cor} may be considered to be representative of an equivalent activity per unit area in the object, at measurement position m, assuming a uniform activity per unit area, and in the absence of screens in the object, this corresponding to an infinite emission energy.

Step 244: forming a corrected observation vector for each measurement m.

yₘ^{cor} corresponds to a corrected observation vector for measurement m. It is a question of an estimate of an observation vector corresponding to an object the activity of which is Φₘ^{cor}. yₘ^{cor} may be considered, to a first approximation, to be representative of a spectrum that would be measured, in position m, if the equivalent activity were Φₘ^{cor}.

Step 245: forming a corrected observation vector for all of the measurements.

The size of yₘ^{cor} is L, which corresponds to the number of emission energies in question. From each vector yₘ^{cor}, a corrected observation vector may be formed, in a way analogous to (2), such that:

$${y}^{cor} = [ \begin{matrix}{y}_{1}^{cor} ( {λ}_{1} ) \\ {y}_{1}^{cor} ( {λ}_{L} ) \\ {y}_{M}^{cor} ( {λ}_{1} ) \\ {y}_{M}^{cor} ( {λ}_{L} )\end{matrix} ] . \qquad ( 33 )$$

The size of y^{cor} is ML

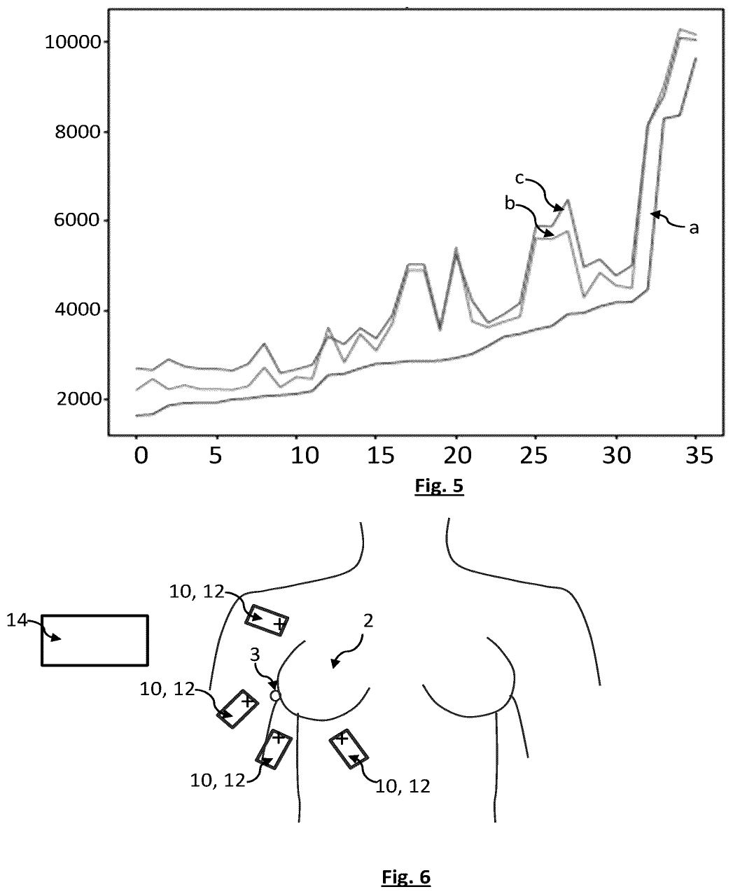

FIG. 5 shows, for various simulated measurements (x-axis):
curve a: vector y resulting from the observations, at the energy 129.3 keV;
curve b: vector y corrected, this corrected vector being obtained by modelling what would happen with screens in an object removed;
curve c: vector y^{cor} obtained by implementing steps 241 to 245 based on the vector represented by curve a, again at the energy 129.3 keV. To obtain this curve, a simulated measurement scene was taken into account, this scene containing three ²³⁹Pu hot spots each positioned in a 0.5 cm thick enclosure formed from a material composed of 30% (mass fraction) Pb and 70% Si. The three hot spots were placed:
   the first, in the centre of a hollow steel sphere with a radius of 0.5 cm;
   the second, behind a 0.5 cm thick steel plate;
   the third, without a screen.

Curve b) was obtained by simulation, with screens removed. It corresponds to the “ground truth”. It may be seen that curve c) is a good approximation, since it is sufficiently close to curve b).

Logically, the values forming curves b) and c) are greater than those forming curve a). This is due to the fact that curve a) results from measurements taking into account actual attenuation in the examined object.

Step 246: forming a model allowing the corrected observation vector to be estimated. It is a question of an iterative estimation, analogous to the iterations described in connection with steps 150 to 190. Each iteration corresponds to an iteration index k.

y^{cor} is a vector of size ML, just like y. Based on y^{cor}, it is possible to write:

$${\hat{y}}_{N , k}^{cor} = [ {G}_{k}^{0} ⊙ {H}_{k}^{0} ] {ϕ}_{k}^{0} \qquad ( 34 )$$

The objective of the initialisation is to establish a vector of initial parameters θₖ⁰, bounding the matrices Gₖ and Hₖ in each iteration k, and a vector ϕₖ⁰. The matrices Gₖ⁰ and Hₖ⁰ correspond respectively to the matrices Gₖ and Hₖ parameterized by θₖ⁰.

ϕₖ⁰ is an estimate of an activity of the N hot spots in question.

Step 247: maximum likelihood optimisation

This step is analogous to step 180 described above. Using expression (13), an initial likelihood function is established:

$${j}_{mv , N , k} ( {θ}_{k}^{0} , {ϕ}_{k}^{0} ) = - \frac{1}{2} {( {y}^{cor} - {\hat{y}}_{N , k} )}^{T} {W}_{k}^{0} ( {y}^{cor} - {\hat{y}}_{N , k} ) \qquad ( 35 )$$

$$with$$

$${W}_{k}^{0} = diag ( \frac{1}{{y}^{cor}} )$$

Then, analogously to (23)

$${θ}_{k}^{0} , {ϕ}_{k}^{0} = {arg min}_{{θ}_{k} , {ϕ}_{k}} ( {j}_{mv , N , k} ( {θ}_{k}^{0} , {ϕ}_{k}^{0} ) ) \qquad ( 36 )$$

Expression (36) is solved as the iterations k progress.

Step 248: it is a question of launching a new iteration until the iteration stop criterion is met (cf. step 190).

Step 249: this step is optional. As described in connection with steps 200 and 210, steps 246 to 248 may be reiterated Q times, each iteration being indexed by the index q. In each reiteration, a pair of values (θₖ⁰,ϕₖ⁰)_{q} is obtained. After the Q iterations, the pair of values for which the likelihood is maximum is selected.

After initialisation, the vectors θₖ⁰,ϕₖ⁰ are used to initialise the solution described in connection with step 180, when the iteration index k is equal to 1.

### Dose Estimation

According to one possibility, after step 230, it is possible to estimate, at various points, a dose generated by the \hat{N} identified hot spots, and the parameter vector θ_{\hat{N}}. The main steps of this variant have been shown in FIG. 3D.

Step 250: matrix formation

4 matrices G, A and D, Δ of size ML×\hat{N} may be formed using \hat{N} and the parameters θ_{\hat{N}} resulting from step 230.

The matrix G is a distance matrix similar to the matrix Gₖ described with respect to step 150, in connection with (3).

$$G = [ \begin{matrix}\frac{1}{{‖ {p}_{1} - {π}_{1} ‖}^{2}} & & \frac{1}{{‖ {p}_{1} - {π}_{\hat{N}} ‖}^{2}} \\ ⋮ & ⋯ & ⋮ \\ \frac{1}{{‖ {p}_{M} - {π}_{1} ‖}^{2}} & & \frac{1}{{‖ {p}_{M} - {π}_{\hat{N}} ‖}^{2}} \\ ⋮ & ⋱ & ⋮ \\ \frac{1}{{‖ {p}_{1} - {π}_{1} ‖}^{2}} & & \frac{1}{{‖ {p}_{1} - {π}_{\hat{N}} ‖}^{2}} \\ ⋮ & ⋯ & ⋮ \\ \frac{1}{{‖ {p}_{M} - {π}_{1} ‖}^{2}} & & \frac{1}{{‖ {p}_{M} - {π}_{\hat{N}} ‖}^{2}}\end{matrix} ] \qquad ( 40 )$$

An attenuation matrix is formed, in a similar way to the attenuation matrix Aₖ described with respect to step 150, in connection with (5).

$$A = [ \begin{matrix}{e}^{- \frac{{τ}_{1.1}}{{λ}_{1}}} & & {e}^{- \frac{{τ}_{1 , N}}{{λ}_{1}}} \\ ⋮ & ⋯ & ⋮ \\ {e}^{- \frac{{τ}_{M , 1}}{{λ}_{1}}} & & {e}^{- \frac{{τ}_{M , \hat{N}}}{{λ}_{1}}} \\ ⋮ & ⋱ & ⋮ \\ {e}^{- \frac{{τ}_{1.1}}{{λ}_{L}}} & & {e}^{- \frac{{τ}_{1 , \hat{N}}}{{λ}_{L}}} \\ ⋮ & ⋯ & ⋮ \\ {e}^{- \frac{{τ}_{M , 1}}{{λ}_{L}}} & & {e}^{- \frac{{τ}_{M , \hat{N}}}{{λ}_{L}}}\end{matrix} ] \qquad ( 41 )$$

A matrix D of absorption coefficients is established

$$D = [ \begin{matrix}d ( {λ}_{1} ) & & d ( {λ}_{1} ) \\ ⋮ & ⋯ & ⋮ \\ d ( {λ}_{1} ) & & d ( {λ}_{1} ) \\ ⋮ & ⋱ & ⋮ \\ d ( {λ}_{L} ) & & d ( {λ}_{L} ) \\ ⋮ & ⋯ & ⋮ \\ d ( {λ}_{L} ) & & d ( {λ}_{L} )\end{matrix} ] \qquad ( 42 )$$

Each term d(λₗ) corresponds to a mass absorption coefficient (i.e. to a coefficient of absorption per unit mass) at the energy λₗ.

An energy matrix κ, of size ML×\hat{N} is also established:

$$Λ = [ \begin{matrix}{λ}_{1} & & {λ}_{1} \\ ⋮ & ⋯ & ⋮ \\ {λ}_{1} & & {λ}_{1} \\ ⋮ & ⋱ & ⋮ \\ {λ}_{L} & & {λ}_{L} \\ ⋮ & ⋯ & ⋮ \\ {λ}_{L} & & {λ}_{L}\end{matrix} ] \qquad ( 43 )$$

Based on the matrices G, H, A and A, a dosimetric response matrix R′, of size ML×\hat{N}, is established.

$${R}^{′} = G ⊙ H ⊙ A ⊙ Λ \qquad ( 44 )$$

Step 260: estimating a dose rate at least at one measurement point

A vector DR, of size M, is then computed, each term DR(m) of which is an estimate of the dose rate at the measurement point m.

$$D R = \frac{1}{4 π} {R}^{′} ϕ \qquad ( 45 )$$

Expression (45) makes it possible to estimate a depth dose rate, assuming electronic equilibrium, the dose rate being equal to the kerma rate. The estimate is correct when the contribution of scattered photons is negligible compared to the contribution of unscattered photons.

The dose rate between measurement points m may then be estimated by interpolation, so as to estimate a dose rate at points other than the measurement points.

The dosimetric response matrix R′ may be established taking into account only some of the measurement points, or even a single measurement point.

### Non-Spectrometric Embodiment

In the embodiment described above, the detector had a spectrometric function. The input data of the algorithm described with reference to FIG. 3A are spectra Sₘ measured in various measurements m, each measurement m corresponding to one position and orientation of the detector. Such an embodiment is suitable when the hot spots are formed from a plurality of isotopes. This notably corresponds to applications of the method to nuclear installations, waste or processing equipment, or even to civil-engineering structures.

The algorithms described with reference to FIGS. 3A to 3D may be applied to a count-rate-measuring modality, in which, in each measurement, the measured quantity CRₘ (count rate) is the number of pulses per second detected by the measuring circuit 12.

The detector 10 and the measuring circuit 12 may be simpler than in the spectrometric embodiment. Thus, the detector 10 may be a solid or gaseous detector, connected to a measuring circuit allowing the number of pulses detected per unit of time to be determined. According to one possibility, the measuring circuit determines the count rate in a particular amplitude range, this being equivalent to addressing only a single spectral band.

It will be understood that, in this embodiment, L=1 and J=1—there is only one spectral band, which corresponds to the pulse-amplitude range in which the measuring circuit determines the count rate. There is only a single isotope, or a single mixture of isotopes, in each hot spot.

The nuclear field is one possible field of application of this method, when the emission spectrum is simple, and/or dominated by a single radioelement, and when attenuation need not be taken into account. Another is the medical field, one example of application being detection of hot spots in a body previously injected with a radioactive isotope. One application may be detection of sentinel lymph nodes when the radioactive isotope is configured to bind to cancer cells. In such an application, there is only a single emission energy and the attenuation of the emitted radiation may be neglected. The user uses a compact detector, which may be easily manipulated by hand. The detector may be coupled to a positioning unit, allowing the respective positions of the detector at each measurement point to be determined. FIG. 6 shows one application of detection of hot spots 3, in the present case sentinel lymph nodes, detection being achieved by placing a portable assembly, made up of the detector 10 and measuring circuit 12, at various measurement points around a body 2 of a person.

The steps described with reference to FIG. 3A are followed. In this embodiment, step 115 is not implemented. In step 120, the observation vector yₘ corresponds to the count rate CRₘ associated with measurement m. A branching ratio may optionally be taken into account i_{L}.

Thus, in step 120,

$${y}_{m} = C {R}_{m} \qquad ( 50 )$$

$$or$$

$${y}_{m} = \frac{C {R}_{m}}{{i}_{L}} \qquad ( {50}^{′} )$$

It is preferable to take the branching factor into account if it is desired to obtain a quantification of each hot spot. It is optional if the main objective is to locate the hot spot, the quantification of the activity being only indicative.

An observation vector y of size M is formed.

$$y = [ \begin{matrix}{y}_{1} \\ ⋮ \\ {y}_{M}\end{matrix} ] \qquad ( 52 )$$

Steps 130, 140 and 150 are implemented. In step 150, matrices Gₖ and Hₖ Of sizes (M,N) are defined such that

$${G}_{k} = [ \begin{matrix}\frac{1}{{‖ {p}_{1} - {π}_{1 , k} ‖}^{2}} & & \frac{1}{{‖ {p}_{1} - {π}_{N , k} ‖}^{2}} \\ ⋮ & ⋯ & ⋮ \\ \frac{1}{{‖ {p}_{M} - {π}_{1 , k} ‖}^{2}} & & \frac{1}{{‖ {p}_{M} - {π}_{N , k} ‖}^{2}}\end{matrix} ] \qquad ( 53 )$$

$$and$$

$${H}_{k} = [ \begin{matrix}h ( {φ}_{{k}_{1.1}} ) & & h ( {φ}_{{k}_{1 , N}} ) \\ ⋮ & ⋯ & ⋮ \\ h ( {φ}_{{k}_{M , 1}} ) & & h ( {φ}_{{k}_{M , N}} )\end{matrix} ] \qquad ( 54 )$$

The matrix Aₖ is not used.

The response of the detector may be assumed to be isotropic, in which case h(φₖ_{_{1,n}}) has the same value

Steps 160, 170, 180 and 190 are implemented with L=1, just like steps 200 to 230. In these steps y (m,λₗ)=y(m) and. ŷ_{N,k}(m;λₗ)=ŷ_{N,k}(m)

The variants illustrated in FIGS. 3B to 3D may be implemented with this embodiment. The dose rate is estimated taking into account the emission energy of the radioactive isotope in question. In medical applications, this makes it possible to estimate dose rate at each measurement position. The device makes it possible both to locate hot spots, and to provide quantitative radiation-protection data. By estimating the duration of the measurements at each observation point, it is possible to estimate the integral dose during an intervention. Thus, advantageously, when the detector is moved manually, the device comprises a chronometer allowing an estimation of a duration of each measurement.

### Experimental Trials

The measuring method was implemented using a high-purity germanium detector (HP broad-energy Ge detector 3830): area 38 mm² and thickness 30 mm. The detector was positioned in various positions around a glove box. The isotope employed was 239Pu.

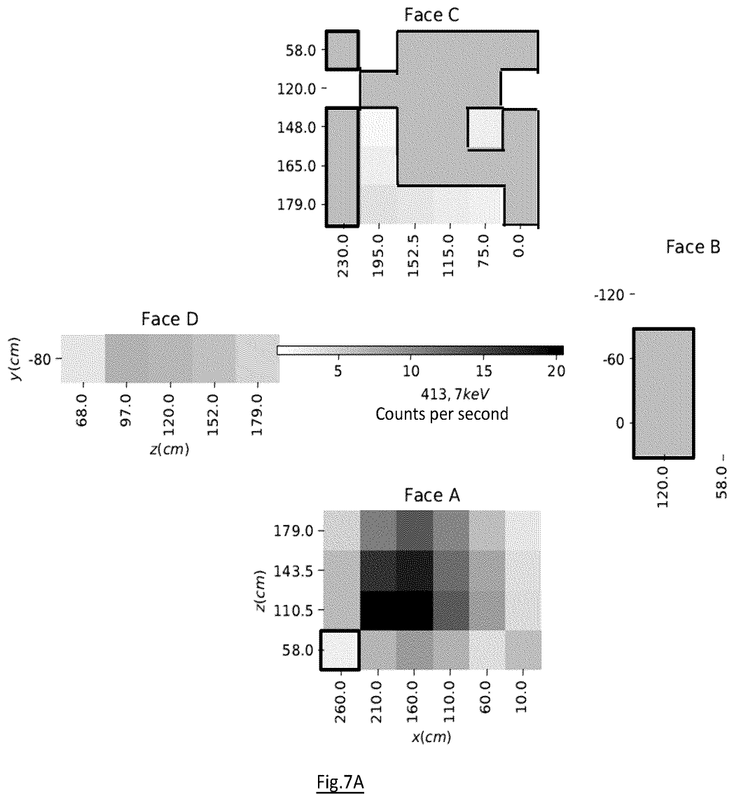

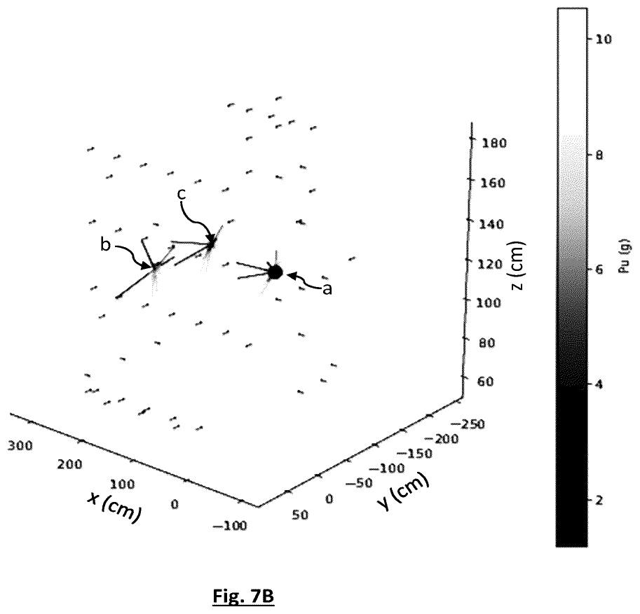

FIG. 7A shows a map of photon flux (pulses detected per second, or hits per second) measured at 413 keV. It is a question of values of the spectrum Sₘ measured in various measurements m, divided by the counting time. The greyscale represents the number of photons detected per second at this energy. The framed regions are regions that were inaccessible with the detector. This is moreover one advantage of the invention: it makes it possible to generate a map of an object in a cluttered environment, by placing a compact detector in various positions around the object. FIG. 7A shows the map generated along 4 faces of the glove box: face A, face B, face C and face D.

FIG. 7B shows an estimate of the location and mass of the material (Pu) of the hot spots, obtained implementing the method such as described above. The examined glove box contained a workbench, comprising a piece of marble supporting a lathe. Implementation of the invention allowed three hot spots to be located. The three hot spots were located at the level of the piece of marble, the most intense (point b in FIG. 7B) being vertically in line with the cutting region of the lathe. A second hot spot (point c in FIG. 7B) was positioned in a region containing a tool holder. Lastly, a third hot spot (point a in FIG. 7B) was positioned between the glove-box wall and the stand of the lathe.

The sum of the activities of the detected hot spots was consistent with a total activity given by another retention-measuring method.

This trial attested to the relevance of the method. It makes it possible, using a simple and inexpensive detector, and under field conditions, to estimate the amount and distribution of activity in an object.

In the preceding examples, use of a detector having simple shielding has been described. The invention is applicable to a collimated detector, the only impact being a modification of the matrix H.

The invention may be applied to inspection of any other object: equipment or structure of a nuclear installation, including a civil-engineering structure, location of radioactivity in the environment, or location and quantification of hot spots in-vivo, the object being a part of a human or animal body.

In the preceding examples, use of a non-pixelated detector has been described. The invention is also applicable to pixelated detectors, each pixel of which forms one elementary detector. This allows the number of measuring points to be multiplied. In each detector position, as many measurements are obtained as there are pixels.

The invention, admittedly at the cost of a lower spatial resolution than achieved with gamma imaging, makes it possible to obtain a usable result in regard to location of hot spots, and quantification of their respective activities in an object, with a much lower number of measurement points, and with equipment that is inexpensive and simple to implement. One important aspect is that the invention in addition does not require any assumptions to be made about the attenuation of the object: when the attenuation matrix is used, the attenuation of the hot spots is estimated together with the position and intensity of the hot spots, in the parameter vector.

1. A method for locating hot spots in an object, each hot spot emitting gamma photons at least at one emission energy, the method using a measuring device, the measuring device comprising:
a detector configured to detect the gamma photons, and to form a pulse on each detection of a gamma photon;
a measuring circuit, configured to determine a number of pulses;
the method comprising the following steps:
a) acquiring measurements, with the detector facing the object, each measurement being assigned to a measurement position and an orientation of the detector, the measurements being acquired by placing the detector in various measurement positions and/or with various orientations with respect to the object;
b) processing the measurements, by means of the measuring circuit, so as to extract count rates of pulses in each measurement;
c) forming an observation vector based on the count rates extracted in step b);
d) selecting a number of hot spots within the object;
e) initialising a parameter vector, containing a position of at least one hot spot within the object;
f) based on the initialised parameter vector resulting from e), or on the parameter vector resulting from a previous iteration, updating a direct matrix model, relating an estimated observation vector to an intensity vector, the intensity vector containing an estimate of the intensity of each hot spot of the selected number of hot spots;
g) inverting the direct matrix model, by means of an optimisation algorithm, so as to update the parameter vector and the intensity vector;
h) reiterating steps f) and g) until an iteration stop criterion is met, so as to obtain, following the last iteration, an estimate of the parameter vector and intensity vector corresponding to the selected number of hot spots.

2. The Method of claim 1, wherein:
the measuring circuit is a spectrometric measuring circuit, configured to form a spectrum, the spectrum corresponding to a number of gamma photons detected in various channels, each channel corresponding to an energy of the detected photon;
the measuring circuit comprises a spectrometry unit configured to identify at least one emission peak in the spectrum formed by the spectrometric measuring circuit, each emission peak extending about an emission energy;
wherein:
in step a), each measurement is a spectrum;
step b) comprises processing spectra, by means of the spectrometry unit, so as to extract count rates from each emission peak.

3. The method of claim 1, wherein, in step g), the inversion comprises minimising a cost function, the cost function quantifying a discrepancy between
the estimate of the observation vector obtained in step f);
the observation vector formed in step c).

4. The method of claim 3, wherein step g) is performed by a maximum likelihood algorithm.

5. The method of claim 1, wherein:
steps d) to h) are reiterated so that, in each iteration of steps d) to h), different numbers of hot spots within the object are respectively selected;
the method comprises determining a validity indicator associated with each iteration of steps d) to h), the validity indicator being associated with the number of hot spots, within the object, selected in each iteration;
the method comprises estimating the most likely number of hot spots depending on the various validity indicators respectively associated with various numbers of hot spots within the object.

6. The method of claim 5, wherein the validity indicator is an Akaike information criterion.

7. The method of claim 1, wherein the direct matrix model comprises a response matrix formed of a Hadamard product between at least:
a distance matrix, containing the respective distances between each measurement position and the position of each hot spot, wherein each term of the distance matrix contains a square of a distance between a measurement position and a position of one of said hot spots, the position of each hot spot forming a parameter of the direct matrix model;
an efficiency matrix, expressing the efficiency of the detector, wherein each term the distance matrix is a detection efficiency of the detector for a position and orientation of the detector with respect to the object, and for a position of a hot spot at the at least one emission energy.

8. Method according to claim 7, wherein the response matrix is formed from a Hadamard product between the distance matrix, the efficiency matrix and an attenuation matrix, the attenuation matrix expressing an attenuation of the photons emitted by each hot spot in the object, each term of the attenuation matrix containing an attenuation factor quantifying, at the at least one emission energy, an attenuation between a position of a hot spot within the object and a position of the detector with respect to the object, each attenuation factor forming one parameter of the direct matrix model.

9. The Method of claim 8, wherein step e) comprises:
e1) based on the observation vector resulting from c), computing an observation vector in the absence of attenuation in the object;
e2) estimating the observation vector in the absence of attenuation in the object using an auxiliary direct matrix model comprising the distance matrix and the efficiency matrix;
e3) inverting the auxiliary direct matrix model, so as to estimate an initialised parameter vector and an initial intensity vector, said initialised parameter vector and said initial intensity vector corresponding to the number of hot spots selected in step d).

10. The method of claim 3, wherein:
steps e) to h) are reiterated with the same number of selected hot spots selected in d);
the method comprises comparing cost functions resulting from each step g) of each of said iterations of steps e) to h), the parameter vector and the intensity vector, for the number of hot spots selected, being those corresponding to the lowest minimized cost function.

11. The method of claim 1, wherein step g) comprises:
g1) applying a gradient descent algorithm to update the parameter vector, based on an initial intensity vector or on the intensity vector resulting from a previous iteration of steps f) and g);
g2) applying an inversion algorithm, to estimate the intensity vector, using the parameter vector resulting from g1).

12. The method of claim 8, wherein, for a given number of selected hot spots, the method comprises:
a first series of iterations of steps e) to h), wherein the response matrix consists of a Hadamard product of the distance matrix and of the sensitivity matrix of the detector;
a second series of iterations of steps e) to h), wherein the response matrix is formed by a Hadamard product of the distance matrix, of the sensitivity matrix of the detector and of the attenuation matrix;
the position and activity of the hot spots resulting from the first series of iterations of step e) to h) is used to initialise the inversion of the direct model in the first iteration of the second series of iterations of steps e) to h).

13. The method of claim 1, wherein step b) comprises selecting at least one emission energy of a predetermined isotope, so as to extract the count rates at each selected emission energy.

14. The method of claim 13, wherein steps b) to h) are repeated, selecting at each repetition of step b), at least one emission energy of various isotopes.

15. The method of claim 1, comprising, following step h), estimating a dose rate at least at one measurement point, based on the intensity vector and on the parameter vector resulting from said step h).

16. The method of claim 7, comprising:
following step h), estimating a dose rate at least at one measurement point, based on the intensity vector and on the parameter vector resulting from said step h).
updating the distance matrix and the efficiency matrix, depending on the parameter vector resulting from step h);
taking into account mass absorption coefficients at the least at one emission energy;
estimating the dose rate at each measurement point based on the distance matrix, on the efficiency matrix and on the mass absorption coefficients.

17. A device configured to estimate a position of hot spots in an object, the device comprising:
a detector, configured to detect gamma photons, and to form a pulse on each detection, the detector being movable around the object, so as to be able to be placed in a plurality of positions and/or with various orientations with respect to the object;
a measuring circuit, configured to determine a number of pulses detected by the detector;
a processing unit, programmed to carry out steps c) to h) of the method according of claim 1, based on the number of pulses detected by the measuring circuit.

18. The device of claim 17, wherein:
the measuring circuit is a spectrometric measuring circuit, configured to form a spectrum, the spectrum corresponding to a number of photons detected in various channels, each channel corresponding to an energy of the detected photon;
the measuring circuit comprises a spectrometry unit, configured to identify emission peaks in the spectrum formed by the spectrometric measuring circuit.

19. A Storage Medium, configured to be connected to a computer, comprising instructions for carrying out steps c) and e) to h) of the method according to claim 1 based on count rates resulting from measurements carried out using a gamma-photon detector around an object.
